(19) United States
(12) Patent Application Publication
(10) Pub. No.: US 2011/0020589 A1
(43) Pub. Date: Jan. 27, 2011

(54) COMBINATION PLATE

(76) Inventor: Kuo-Ying KAN, Mountainside, NJ (US)

Correspondence Address: Muncy, Geissler, Olds & Lowe, PLLC, 4000 Legato Road, Suite 310, FAIRFAX, VA, 22033, US

(21) Appl. No.: 12/507,432

(22) Filed: Jul. 22, 2009

(51) Int. Cl. B32B 3/06

(52) U.S. Cl. 428/83

(57) ABSTRACT

The present invention primarily relates to a combination plate that can be conveniently assembled and disassembled, which, when combined, can form continuous surfaces. The combination plate is formed from an integral body using an extrusion molding method after plastic material is made to cover metal strips. The combination plate is provided with a flat surface, one side of which protrudes forward to form a C pocket, and the position of the C pocket is lower than the flat surface; moreover, a bottom portion of the C pocket is provided with an inner surface. The side opposite the C pocket protrudes downward to form a J column. Accordingly, using mutual clasping connections between the J columns and the C pockets provides the combination plates with airtight and sound insulation, heat preservation, insulation, moisture and water resistance effectiveness, not seen in the prior art.

### BACKGROUND OF THE INVENTION

(a) Field of the Invention

A ‘combination plate’ of the present invention primarily relates to a combination plate that can be conveniently assembled and disassembled, which, when combined, can form continuous surfaces (such as wall surfaces, floors, roofs, and so on).

(b) Description of the Prior Art

At present, in many locations, such as homes, offices, roofs, and so on, regardless of whether refurbishment needs to be carried out on the floor surfaces or wall surfaces, in order not to damage the original structural surfaces, combination floors or combination wall plates are mainly chosen to carry out refurbishment, and many variations can be achieved using the combination floors or combination wall plates.

For example, the overwhelming majority of combination floor boards in widespread use are fabricated from timber or use imitation wood manufactured from plastic material. However, taking into account the convenience of construction, the combination floor boards are of fixed size, enabling the user to select and purchase the appropriate sized boards themselves. Nevertheless, such combination floor boards can only be exclusively used to achieve the effect of elevating the floor.

Hence, in order to meet the requirements to cover a different area, the user must select and purchase different combination floor boards or combination wall plates matching the area he wants to cover.

Accordingly, not only does it create an annoyance for the user who has to select and purchase the appropriate boards, furthermore, when using the combination floor boards or combination wall plates, because each type of combination floor board or combination wall plate is designed for separate use, and are not interchangeable, thus, use of the combination floor boards or combination wall plates is restricted, and prevents widespread use for refurbishment.

Moreover, the majority of such combination floor boards or combination wall plates are structured from a single material, resulting in the combination floor boards or combination wall plates having poor strength, which are easily fractured or damaged from external forces. More particularly, they lack insulation properties including moisture and water resistance, sound insulation and heat preservation, and are far from providing airtight effectiveness.

Hence, in order to increase the use of combination plates, the inventor of the present invention has invented a ‘combination plate’, which primarily uses a simple design to not only provide the combination plates with excellent structural ability, which increases the strength of the combination plates, but also reduce slippage of the combination plates, as well as providing the combination plates with the ability to effect many different combination variations. In particular, the combination plate is provided with airtight and sound insulation, heat preservation, insulation, moisture and water resistance effectiveness.

### SUMMARY OF THE INVENTION

The primary objective of the present invention lies in providing a combination plate that can be conveniently assembled and disassembled and has excellent structural ability to facilitate construction, while at the same time increasing the strength of the combination plate and preventing shrinkage and distortion, as well as further providing the combination plate with airtight and sound insulation, heat preservation, insulation, moisture and water resistance effectiveness.

In order to achieve the above objective, the combination plate of the present invention primarily uses plastic material to cover metal strips, after which an extrusion method is used to form an integral body. The combination plate is provided with a flat surface, and one side protrudes forward to form a C pocket. Position of the C pocket is lower than the flat surface, and a bottom portion of the C pocket is provided with an inner surface. The side opposite the C pocket protrudes downward to form a J column, and the J column is slightly higher than the position of the C pocket. Accordingly, using mutual clasping of the J column and the C pocket between two of the combination plates enables achieving a connection between the combination plates. In addition, the metal strips enveloped by the combination plate increase the strength of the combination plate, and at the same time prevents shrinkage and distortion of the combination plate, thereby forming a combination plate with better structural ability.

Another objective of the present invention lies in providing the combination plate with an excellent anti-slip effect.

In order to achieve the above objective, the present invention primarily uses a non-slip mat located on the bottom surface and the lower part of the J column, thus, after combining a plurality of the combination plates, a better frictional force is formed between the non-slip mats on the lower part and the bottom surface and a floor or wall surface, which prevents the combination plates from slipping when laid on the floor or wall surface. In addition, when a plurality of the combination plates are combined, mutually clasping between the J columns and the C pockets is used to assemble the combination plates, thus, when the J columns are clasped within the C pockets, the non-slip mats on the lower parts of the J columns increase the frictional force between the J columns and the C pockets, thereby further preventing slippage from occurring when combining a plurality of the combination plates, and resolving the annoyance resulting from unevenness of the combination plates on the floor or wall surface.

Yet another objective of the present invention lies in providing the combination plate with the ability to effect multiple combination variations.

In order to achieve the above objective, the combination plate of the present invention is further configured with a combination member, and one side of the combination member is provided with a clasp projection corresponding to the C pocket, while a holding groove is located in the opposite side. Accordingly, mutual clasping of the clasp projection and the C pocket enables the combination member to be fixed to the combination plate, and the holding groove can be used to hold glass or a door plate, thereby enabling the combination plate to provide multiple combination variations.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an isometric schematic view of a first embodiment of the present invention.

FIG. 2 is side schematic view of the first embodiment of the present invention.

FIG. 3 is side schematic view of a second embodiment of the present invention.

FIG. 4 is side schematic view of a third embodiment of the present invention.

FIG. 5 is an isometric schematic view of an assemblage according to the present invention.

FIG. 6 is a side schematic view of the assemblage according to the present invention.

FIG. 7 is a schematic view of an assemblage of another embodiment according to the present invention.

FIG. 8 is an isometric schematic view of a fourth embodiment of the present invention.

FIGS. 9A-9D are schematic views of the C pocket configured at various different angles according to the present invention.

FIGS. 10A-10B are schematic views of the C pocket and a J column configured with various shapes according to the present invention.

FIG. 11 is a schematic view of a fifth embodiment of the present invention.

FIG. 12 is a schematic view of a sixth embodiment of the present invention.

### DETAILED DESCRIPTION OF THE PREFERRED EMBODIMENTS

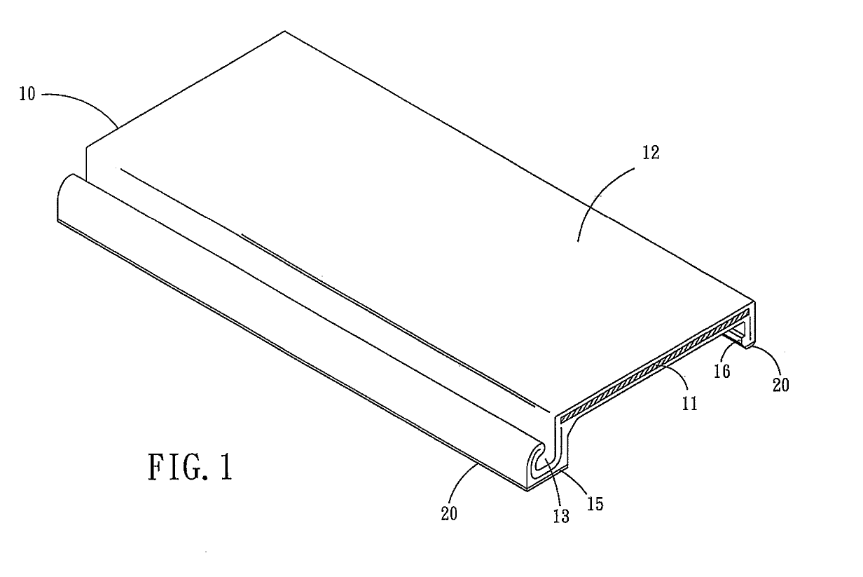

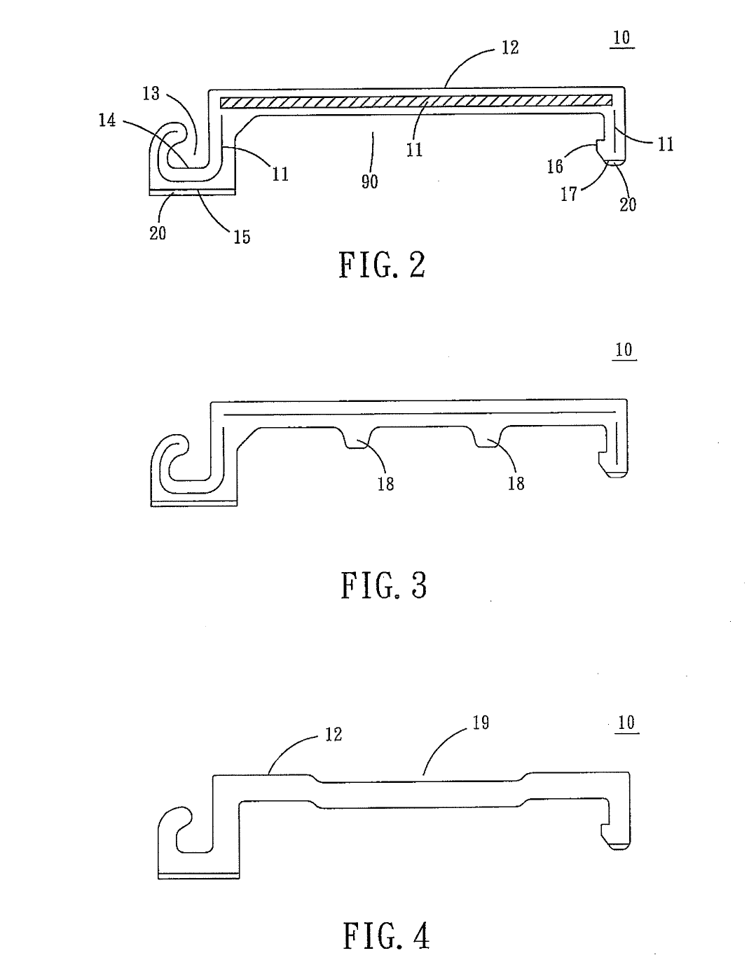

Referring first to FIG. 1 and FIG. 2, a combination plate 10 of the present invention is primarily formed from an integral body using an extrusion molding method after plastic material is made to cover metal strips 11. The combination plate 10 is mainly provided with a flat surface 12, one side of which forms a C pocket 13, and in the embodiment, the opening of the C pocket 13 is upwardly configured. The C pocket 13 is provided with an inner surface 14, position of the inner surface 14 being lower than the flat surface 12, and the bottom portion of the C pocket 13 is provided with a bottom surface 15. In addition, one side of the combination plate 10 downwardly protrudes forming a J column 16 corresponding to the C pocket. The J column 16 is provided with a lower surface 17, the lower surface 17 is positioned to be exactly horizontal with the inner surface 14, and a non-slip mat 20 is further disposed on the bottom surface 15 of the C pocket 13 and the lower part of the lower surface 17 of the J column 16.

In addition, because the combination plate 10 directly envelops the metal strips 11 during extrusion molding, thus, the metal strips 11 are completely covered by the combination plate 10, as depicted in the drawings. There are no restrictions on the thickness of the metal strips 11 enveloped within the combination plate 10, and the thickness of the metal strips 11 can be changed according to different requirements. Moreover, the metal strips 11 can be in the form of foils. Accordingly, envelopment of the metal strips 11 increases the strength of the combination plate 10, and prevents shrinkage and distortion of the combination plate 10, thereby providing the combination plate 10 with a better structure.

Moreover, when the combination plate 10 is laid on a floor, then the non-slip mat 20 disposed on the bottom surface 15 of the C pocket 13 increases frictional force between the combination plate 10 and the floor, thereby preventing the combination plate 10 from slipping on the floor surface.

From the aforementioned configuration, the combination plate 10 is able to form an airtight chamber 90 provided with airtight, heat preservation and sound insulation effectiveness between the C pocket 13 and the J column 16.

Referring to FIG. 3, at least one reinforcing rib 18 can be further located on the bottom portion of the combination plate 10. Two reinforcing ribs 18 are used as a variation of the embodiment of the present invention, and the reinforcing ribs 18 serve to increase the strength of the combination plate 10.

Referring to FIG. 4, at least one groove 19 can be further defined in the flat surface 12 of the combination plate 10. One groove 19 is used as a variation of the embodiment of the present invention, and the groove 19 is used to enhance drainage and effect reinforcement.

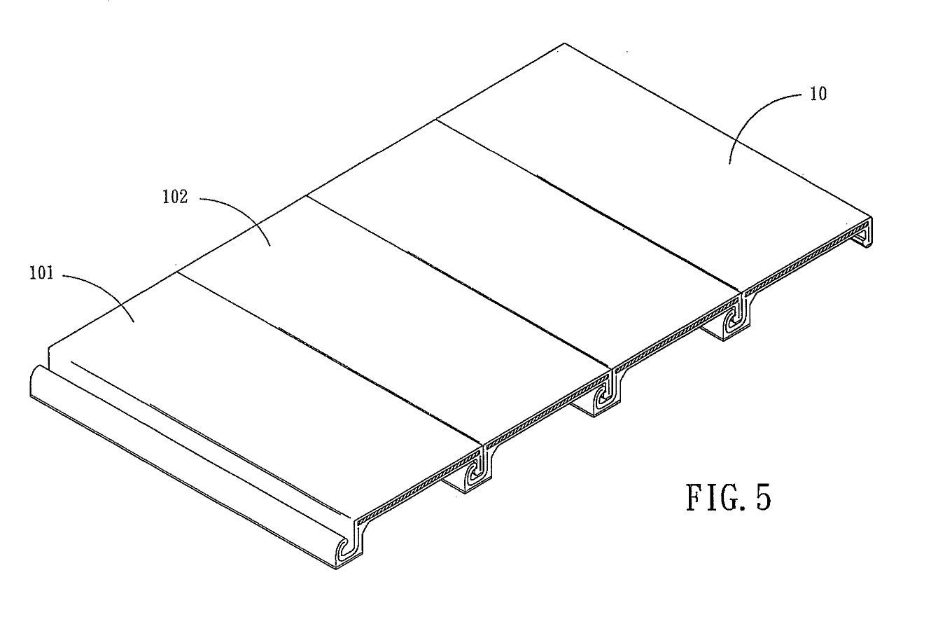

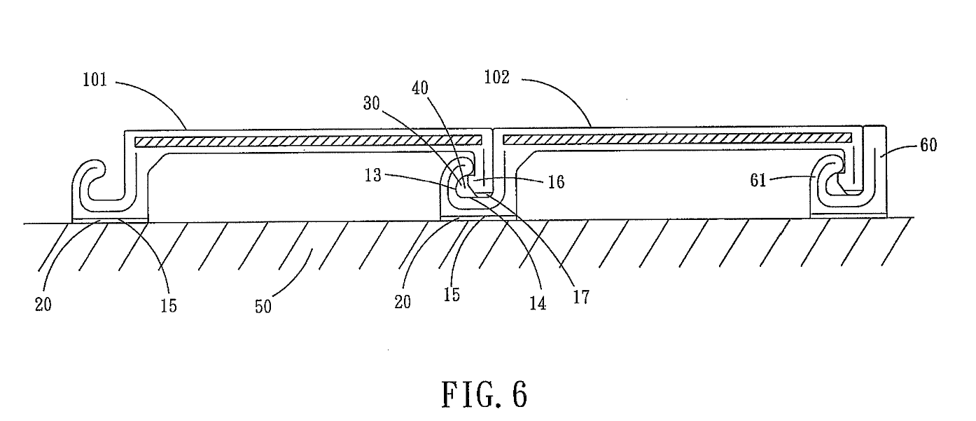

Referring to FIG. 5 and FIG.6, in use, clamping resistance between a plurality of the combination plates 10 is used to clasp the combination plates 10 together. When combining a plurality of the combination plates 10, the J column 16 of a front combination plate 101 is primarily used to clasp into the C pocket 13 of a following combination plate 102, which enables mutual fitting between the lower surface 17 of the J column 16 and the inner surface 14 of the C pocket 13. The clamping effect produced between the C pocket 13 and the J column 16 is used to obtain an effective assemblage between the front combination plate 101 and the following combination plate 102, while further achieving effectiveness to quickly disassemble the assemblage.

Furthermore, in order to prevent the front combination plate 101 and the following combination plate 102 from coming apart, in actual use, an adhesive 40 can be further used to fill a gap 30 formed between the J column 16 and the C pocket 13, thereby providing a more effective clamping between the J column 16 and the C pocket 13, which can not only prevent the front combination plate 101 and the following combination plate 102 from coming apart, but also provide airtight and sound insulation, heat preservation, insulation, moisture and water resistance effectiveness.

In addition, when the plurality of combination plates 10 are laid on an assembling surface 50, the non-slip mats 20 located on the bottom surfaces 15 of the C pockets 13 produce maximum frictional force between the non-slip mats 20 and the assembling surface 50, thereby reducing noise and preventing slippage of the combination plates 10, thus improving safety of use. The non-slip mats 20 are also located on the lower part of each of the J columns 16, hence, when the J columns 16 are made to clasp within the C pockets 13, then the frictional force produced between the non-slip mats 20 and the C pockets 13 further prevents slippage of the J columns 16 in the C pockets 13 from occurring, thereby improving safety in use of the combination plates 10.

When the combination plate 10 is to be fixed to the assembling surface 50, apart from direct attachment means using glue, nails or screws can also be used to penetrate the assembling surface 50 through the inner surface 14 of the C pocket 13 of the combination plate 10, after which the nailheads or screw caps are imbued with an adhesive and the J columns 16 clamped thereto.

Moreover, when the front combination plate 101 is clasped to the following combination plate 102, because the J column 16 of the following combination plate 102 is slightly higher than the C pocket 13, thus, a combination member 60 can be additionally located on the position of the J column 16 of the following combination plate 102. A clasp projection 61 is further located on the front end of the combination member 60, and the clasp projection 61 can clasp onto the J column 16 of the following combination plate 102, thereby preventing slanting of the following combination plate 102 from occurring, and maintaining planeness and stability after the front combination plate 101 and the following combination plate 102 are combined.

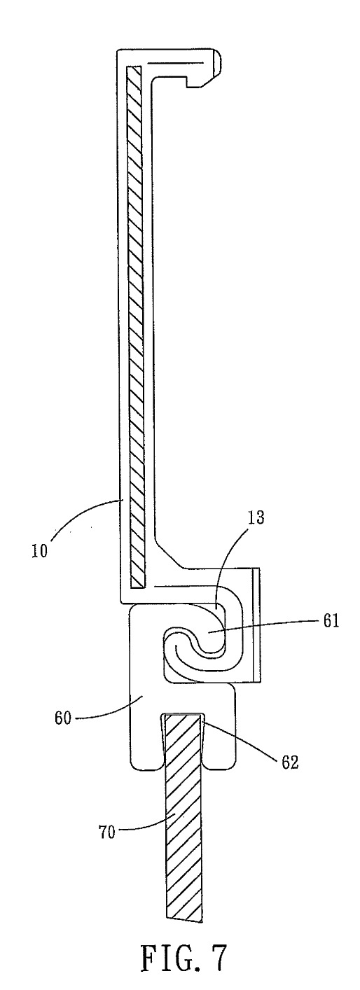

Referring to FIG. 7, the combination member 60 can be further configured with a holding groove 62 corresponding to one side of the clasp projection 61, and the holding groove 62 is provided with elastic holding strength. Accordingly, the mutual clamping effect produced between the clasp projection 61 and the C pocket 13 of the combination plate 10 enables mutual assemblage of the combination member 60 with the combination plate 10. Furthermore, the elastic holding strength produced by the holding groove 62 can hold a decorative sheet 70. The decorative sheet 70 can be glass or a door plate or other sheets used for decorative purposes, thereby enabling the combination plate 10 to assume multiple combination variations.

Referring to FIG. 8, a rough surface processing is carried out on the upper side of the flat surface 12 of the combination plate 10, or an antislip mat 80 is additionally disposed on the flat surface 12, thereby enabling antislip treatment, such as the rough surface or the antislip mat 80, and the like, to achieve antislip effectiveness when the user steps on the flat surface 12 of the combination plate 10, and prevent the user from slipping thereon, thus improving safety in use of the combination plates 10.

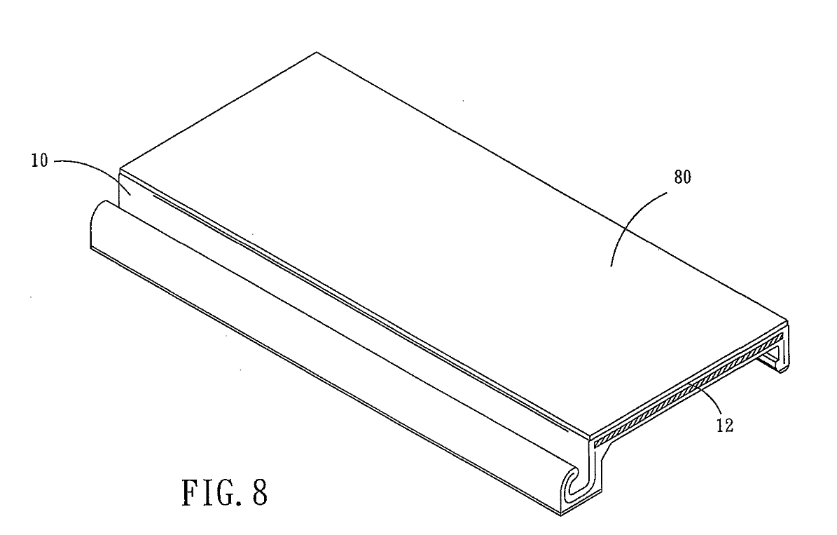

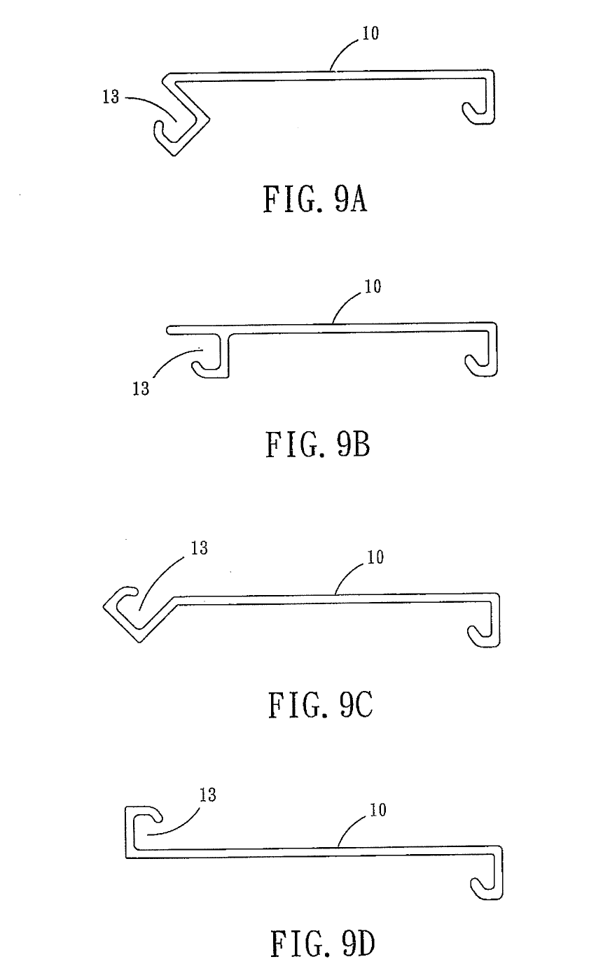

Referring to FIGS. 9A to 9D, and as depicted in the drawings, apart from the opening of the C pocket 13 of the combination plate being upwardly configured, the opening can also be designed to be directed towards various different directions to accommodate different angles and environment needs, such as the opening directed towards a 45 degree angle, a 90 degree angle, a 135 degree angle and a 180 degree angle. However, the configurations listed above for the various different directions of the opening are merely illustrative configurations of the invention, and do not limit the scope of the invention as set forth in the claims.

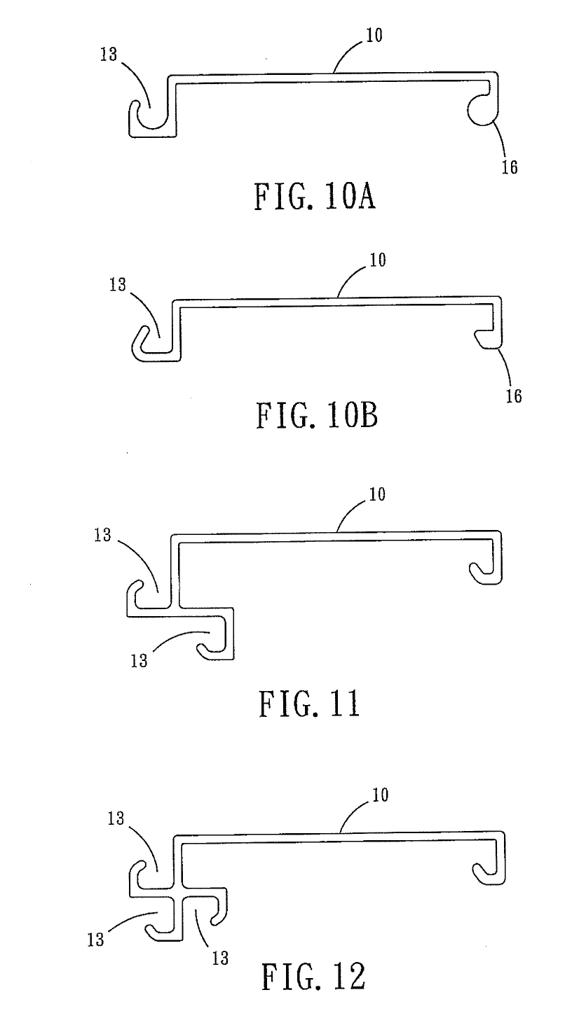

Referring to FIGS. 10A to 10B, and as depicted in the drawings, apart from the configuration of the C pocket 13 forming a C shape, the C pocket 13 can also be formed to present an O form or a triangular form, and the J column 16 is correspondingly modeled to clamp therein. Finally, referring to FIG. 11 and FIG. 12, the combination plate 10 can be configured with more than one of the C pockets 13, with FIGS. 11 and 12 depicting the combination plate 10 configured with two and three C pockets 13 respectively, in which each of the C pockets 13 is arranged so as to be directed towards different directions to better facilitate use of the combination plates 10 by the user in various different environments.

In conclusion, mutual assemblage between a plurality of the combination plates 10 of the present invention can serve as floors, waterproof and heat insulating plates for roofs, waterproof and insulating walls, waterproof mats or eaves, and so on. Moreover, disposition of the combination members 60 can be used to form doors, windows, and the like, while at the same time providing insulation, waterproofing, heat insulation and sound insulation effectiveness.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A combination plate, the combination plate is formed from an integral body using an extrusion molding method after plastic material is made to cover metal strips, the combination plate is provided with an flat surface, one side of the flat surface protrudes forward to form a C pocket, and the position of the C pocket is lower than the flat surface, a bottom portion of the C pocket is provided with a bottom surface, the side of the flat surface opposite the C pocket protrudes downward to form a J column, and the position of the J column is slightly higher than that of the C pocket.

2. The combination plate according to claim 1, wherein a non-slip mat is located on the lower part of the bottom surface.

3. The combination plate according to claim 1, wherein a non-slip mat is located on the lower part of the J column.

4. The combination plate according to claim 1, wherein at least one reinforcing rib is further located on the bottom portion of the combination plate.

5. The combination plate according to claim 1, wherein at least one groove is defined in the flat surface of the combination plate.

6. The combination plate according to claim 1, wherein the metal strips are in the form of foils.

7. The combination plate according to claim 1, wherein the combination plate further comprises a combination member to maintain planeness after combining with another combination plate, and one side of the combination member is provided with a clasp projection corresponding to the C pocket.

8. The combination plate according to claim 7, wherein the combination plate is further configured with a combination member, a clasp projection is located on one side of the combination member, and a holding groove is further provided in another side relative to the clasp projection.

9. The combination plate according to claim 8, wherein the holding groove is provided with elastic holding strength.

10. The combination plate according to claim 1, wherein an upper side of the flat surface has undergone further antislip treatment.

11. The combination plate according to claim 7, wherein an upper side of the flat surface has undergone further antislip treatment.
